(19) United States
(12) Patent Application Publication
(10) Pub. No.: US 2017/0004537 A1
(43) Pub. Date: Jan. 5, 2017

(54) METHODS AND APPARATUS TO ESTIMATE A NUMBER OF ACTUAL MOBILE DEVICES

(71) Applicant: The Nielsen Company (US), LLC, New York, NY (US)

(72) Inventors: Ross Otto, San Francisco, CA (US); Austin W. Albino, San Francisco, CA (US)

(21) Appl. No.: 14/788,657

(22) Filed: Jun. 30, 2015

(51) Int. Cl. G06Q 30/02

(52) U.S. Cl. CPC G06Q 30/0267; G06Q 30/0244; G06Q 30/0261

(57) ABSTRACT

Methods, apparatus, systems and articles of manufacture to reduce a processing burden on a hardware processor estimating a number of actual mobile devices in a geographic region are disclosed. An example method includes accessing mobile device advertisement impression data. The mobile device impression data identifies manufacturers of corresponding mobile devices and respective device identifiers. At least two unique device identifiers of the impression data correspond to a same mobile device. A total number of unique device identifiers associated with a first manufacturer in the impression data is determined. A de-duplication ratio is accessed based on an identity of the first manufacturer. The de-duplication ratio is applied to the total number of unique device identifiers associated with the first manufacturer to estimate the number of actual mobile devices associated with the manufacturer. The estimation is performed without determining that the at least two unique device identifiers correspond to the same mobile device.

### FIELD OF THE DISCLOSURE

This disclosure relates generally to mobile device monitoring, and, more particularly, to methods and apparatus to estimate a number of actual mobile devices.

### BACKGROUND

Competition in telecommunication markets has increased the need for market share metrics. Market share metrics (e.g., the number of users using a particular mobile device) can be useful to network operators for purposes of understanding the mobile devices serviced by their network. Moreover, market share information in the form of competitive performance data can be used by companies to understand technical demands on their networks. For example, market share data in a geographic market can be valuable to a network operator to assess a need for upgrading a wireless network, to launch effective marketing campaigns, to forecast consumer demand for a mobile device, etc.

### BRIEF DESCRIPTION OF THE DRAWINGS

FIG. 1 is diagram of an example market share estimation server constructed in accordance with the teachings of this disclosure to estimate a number of mobile devices shown in an example environment of use.

FIG. 2 is an example data table indicating de-duplication ratios associated with respective mobile device manufacturers.

FIG. 3 is a flow diagram representative of example machine-readable instructions that may be executed to implement the example market share estimation server of FIG. 1 to determine de-duplication ratios to be used in association with the respective mobile device manufacturers.

FIG. 4 is a flow diagram representative of example machine-readable instructions that may be executed to implement the example market share estimation server of FIG. 1 to determine de-duplication ratios to be used in association with the respective mobile device manufacturers based on an adjusted total number of unique device identifiers.

FIG. 4A is an example data table representing a distribution of unique device identifiers by their corresponding demographic segment and market pair.

FIG. 4B is an example data table representing a distribution of a population by corresponding demographic segment and market pairs.

FIG. 4C is an example data table representing calculated adjustment factors corresponding to each demographic segment and market pair.

FIG. 5 is a flow diagram representative of example machine-readable instructions that may be executed to implement the example market share estimation server of FIG. 1 to estimate a mobile device market share and prepare a market share report.

FIG. 6 is an example diagram of an example market share report prepared according to the example flow diagram of FIGS. 4 and/or 5.

FIG. 7 is a block diagram of an example server structured to execute the example machine-readable instructions of FIGS. 3, 4, and/or 5 to implement the example market share estimation server of FIG. 1.

Wherever possible, the same reference numbers will be used throughout the drawing(s) and accompanying written description to refer to the same or like parts.

### DETAILED DESCRIPTION

Competition in telecommunication markets has increased the need for competitive performance data. For example, mobile device manufacturers, retailers, and/or service providers seek to determine market share(s) in various market(s). Such determination(s) may allow the manufacturer, retailer, and/or service provider to make changes to, for example, products, marketing materials, etc. with the end result of increased sales. Often, mobile device sales information is recorded at the time of sale at the point of sale (POS). Such information is often available to the proprietor of the POS (e.g., the retailer), but may not be available to others. As a result, sales information is fragmented (e.g., sales from different businesses may not be shared). Though available, the sales information is traditionally of limited scope. Moreover, sales data represents a total number of devices sold, not necessarily a total number of devices actually in use on a network. For example, some users may purchase their mobile device through a non-retail seller (e.g., a device purchased from a friend). In some examples, a user may purchase multiple devices (e.g., for a trial period), but only use one of the purchased devices (e.g., the other device(s) may be returned). As a result, more accurate measures of market share of mobile devices that are actually being used (as opposed to sold) in any region for any given period of time would be useful.

Example methods and apparatus disclosed herein identify market share by monitoring impressions of mobile advertisements on mobile devices. Many mobile device applications request mobile advertisements. When a mobile device requests an advertisement, a request is transmitted to an advertisement exchange. The request for the advertisement typically includes a device identifier. The advertisement exchange (1) identifies an advertisement to be provided to the mobile device, (2) transmits the selected advertisement to the requesting mobile device, and (3) stores a record of the advertisement impression in association with the device identifier reported by the requesting mobile device.

Many different types and/or formats of device identifiers are used by different mobile devices. For example, some APPLE® mobile devices utilize a Universal Device Identifier (UDID). Formats for such identifiers may change over time and/or be replaced by a different format. For example, APPLE® recently introduced a new architecture for serving advertisements that utilizes a different identifier, an “identifierForAdvertising” (IDFA), which is a cross-application/publisher identifier. Other mobile devices, such as GOOGLE™ ANDROID™ mobile devices, may use a GOOGLE™ “Advertising ID” (ADID). Furthermore, in some instances, mobile devices report encrypted and/or modified versions of the UDID, IDFA, ADID, etc.

Such device identifiers are unique to the device with which they are associated. However, each device may utilize multiple different unique identifiers. For example, a first application on a device may report a UDID, whereas a second application on the same device may report an IDFA. While those identifiers are different and unique, they identify the same device. Accordingly, when a count of unique device identifiers is calculated, in some examples, the count of unique device identifiers might not be representative of an actual number of unique devices. That is, using the number of unique device identifiers alone (e.g., including the UDID and the IDFA that correspond to the same device) may result in an over estimation of the actual number of unique devices. As used herein, an active mobile device is one that is generally in use at least periodically by a person. Thus, a mobile device of a person is active if they used it from time to time. A mobile device that has not been sold to a consumer (e.g., is still on a retailer's shelf) or has been discarded by a user (e.g., service contract terminated, device destroyed, device replaced by a new active device, etc.) and is not being used by another user is not active.

In examples disclosed herein, a de-duplication ratio is calculated and is applied to a total number of unique device identifiers associated with a particular manufacturer to estimate the total number of unique devices identified in association with the particular manufacturer. In examples disclosed herein, multiple de-duplication ratios are calculated corresponding to different manufacturers. Different mobile devices sold by different manufacturers tend to exhibit similar duplicative device identifiers. For example, it has been determined that APPLE® mobile devices often report the UDID and the IDFA. GOOGLE™ ANDROID™ mobile devices produced by a first manufacturer commonly report a GOOGLE™ “Advertising ID”. GOOGLE™ ANDROID™ mobile devices produced by a second manufacturer (different than the first manufacturer) commonly report the GOOGLE™ “Advertising ID” and an encrypted form of the “Advertising ID”. To account for such variations among mobile device manufacturers, examples disclosed herein calculate different de-duplication ratios for different mobile device manufacturers.

In some examples, the total number of unique device identifiers associated with the particular manufacturer is further limited to a geographic region, thereby enabling estimation of a market share within that geographic region. In some examples, a geographic region is also referred to as a market (e.g., a metropolitan area). In examples disclosed herein, de-duplication ratios are calculated in association with a first geographic region. In examples disclosed herein, the first geographic region is a large geographic region (e.g., a geographic region corresponding to a nation, a continent, globally, etc.). In examples disclosed herein, de-duplication ratios corresponding to respective manufacturers are calculated by dividing (a) the total number of known devices associated with a manufacturer and in use in the first geographic region by (b) a total number of unique device identifiers associated with the manufacturer in the first geographic region. In some examples, the total number of unique device identifiers is adjusted using an adjustment factor calculated in association with demographic segment and market pairs. The de-duplication ratio calculated using information associated with the first geographic region (e.g., the known usage information associated with the first geographic region, the records of advertisement impressions associated with the first geographic region) can then be applied to a second geographic region to estimate mobile device market share within the second geographic region.

In some examples, the second geographic region is a smaller geographic region within the first geographic region (e.g., a city within a nation represented by the first geographic region, a state within a nation represented by the first geographic region, a nation within a continent represented by the first geographic region, etc.) However, in some examples, the second geographic region is separate from the first geographic region (e.g., the first geographic region may correspond to a first state, city, or nation while the second geographic region may correspond to a second state, city, or nation different from the first state, city, or nation).

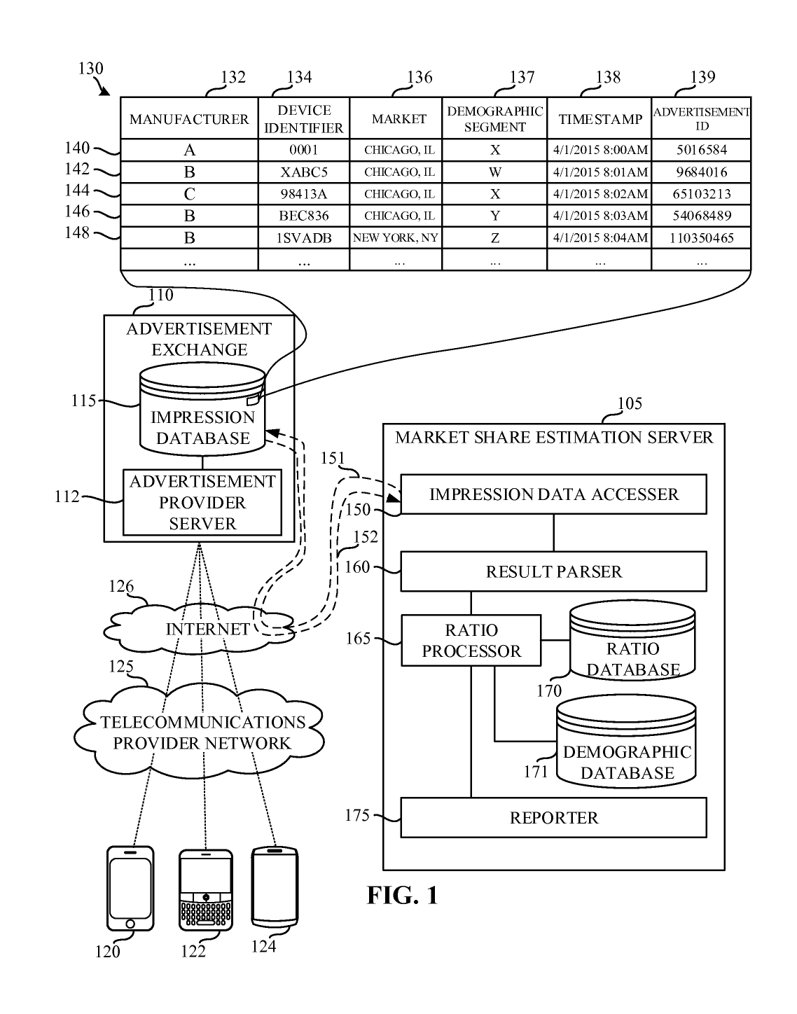

FIG. 1 is diagram of an example market share estimation server 105 constructed in accordance with the teachings of this disclosure to estimate a mobile device market share shown in an example environment of use. The example market share estimation server 105 of this example electronically accesses records of advertisement impressions from an advertisement exchange 110. The example advertisement exchange 110 of FIG. 1 includes an advertisement provider server 112 that services requests for advertisements and stores a record of those requests in an impression database 115. As used herein, an advertisement impression is defined to be a presentation of an advertisement (e.g., a presentation by a requesting device). Therefore, a record of an advertisement impression is a record indicating that an advertisement was transmitted to a requesting device. In some examples, the advertisement impression record further identifies that the advertisement was actually presented (e.g., displayed visually and/or audibly) by the requesting device. In the illustrated example, the impression database 115 stores records of advertisement impressions in association with advertisement requests received from mobile devices 120, 122, 124 via a telecommunications provider network 125. The records of the advertisement impressions are stored in an example data table 130 within the example impression database 115. The example market share estimation server 105 of FIG. 1 accesses records of advertisement impressions stored in the example impression database 115 of the advertisement exchange 110 to estimate mobile device market share(s).

The example market share estimation server 105 of the illustrated example is operated by a monitoring entity such as, for example, The Nielsen Company (US), LLC. Whereas the advertisement exchange 110 of FIG. 1 provides advertisements to the mobile device(s) 120, 122, 124, the market share estimation server 105 of this example is operated by a neutral third party which is not involved in the delivery of advertisements. Moreover, neither the market share estimation server 105 nor the neutral third party provides a service to the mobile devices 120, 122, 124. As such, data collected by the market share estimation server 105 can be trusted as unbiased.

In examples disclosed herein, the example advertisement exchange 110 includes an advertisement provider server 112 configured to automatically provide advertisements to requesting devices (e.g., mobile devices, personal computers, etc.) via, for example, the Internet. In the illustrated example, the example advertisement exchange 110 is hosted by an advertisement server of an advertisement service provider different from the monitoring entity. The advertisement exchange 110 of this example receives advertisements from advertisers so that they can be provided to users (e.g., a user of one or more of the mobile devices 120, 122, 124). In the illustrated example of FIG. 1, a single advertisement exchange 110 is shown. However, in some examples, multiple advertisement exchanges may additionally or alternatively operate in the environment and/or be accessed by the market share estimation server 105.

As noted above, the example advertisement exchange 110 of FIG. 1 includes an advertisement provider server 112. In the illustrated example of FIG. 1, the example advertisement provider server 112 is responsive to requests for advertisements received from the mobile device 120, 122, 124. In the illustrated example, the requests are formatted as hypertext transfer protocol (HTTP) requests. However, any other past, present, and/or future type(s) of requests and/or request protocol(s) may additionally or alternatively be used. For example, the request may be formatted as an HTTP secure (HTTPS) request. In response to the request for an advertisement received from a mobile device 120, 122, 124 (or any other requesting device), the example advertisement provider server 112 selects an advertisement and provides the selected advertisement to the mobile device 120, 122, 124. The example advertisement provider server 112 logs the advertisement request in the impression database 115.

In examples disclosed herein, the example impression database 115 stores records of advertisement impressions corresponding to advertisements provided in response to requests for those advertisements. The example impression database 115 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example impression database 115 may additionally or alternatively be implemented by one or more double data rate (DDR) memories, such as DDR, DDR2, DDR3, mobile DDR (mDDR), etc. The example impression database 115 may additionally or alternatively be implemented by one or more mass storage devices such as hard drive disk(s), compact disk drive(s), digital versatile disk drive(s), etc. While in the illustrated example the impression database 115 is illustrated as a single database, the impression database 115 may be implemented by any number and/or type(s) of databases.

In examples disclosed herein, the example impression database 115 stores impression data in a tabular format such as, for example, the example data table 130 of the illustrated example of FIG. 1. However, the impression data may be stored in any other format or data structure. The example data table 130 of the illustrated example of FIG. 1 includes a manufacturer column 132, a device identifier column 134, a market column 136, a demographic segment column 137, a timestamp column 138, and an advertisement identifier column 139. Each row of the example data table 130 corresponds to an advertisement impression. As such, each row reflects a single occurrence of an advertisement being served in response to a particular request. The example data table 130 of the illustrated example includes a first row 140, a second row 142, a third row 144, a fourth row 146, and a fifth row 148. While in the illustrated example of FIG. 1, the example data table 130 includes five example rows, in practice, the example data table stored in the example impression database 115 will include many rows corresponding to many respective advertisement requests received from many different mobile devices.

The example manufacturer column 132 identifies a manufacturer of the mobile device that originated the advertisement request identified in the corresponding row. In the illustrated example, when storing the record of the advertisement request in the impression database 115, the example advertisement provider server 112 identifies the manufacturer of the mobile device based on data contained in the advertisement request. In some examples, the manufacturer is identified based on a header field in the advertisement request such as, for example, a User Agent field. However, any other past, present, and/or future technique(s) for identifying a manufacturer may additionally or alternatively be used. In some examples, the example manufacturer column may, in addition to and/or as an alternative to representing the manufacturer of the mobile device 120, 122, 124, represent a model of the mobile device 120, 122, 124, a version number of the mobile device 120, 122, 124, and/or any other property and/or characteristic of the mobile device 120, 122, 124. Accordingly, whereas examples illustrated herein refer to identifying a market share of a manufacturer, it is to be understood that market shares based on other mobile device parameters and/or characteristics (e.g., a model, a version number, etc.) may additionally or alternatively be estimated.

The example device identifier column 134 identifies a device identifier provided by the mobile device 120, 122, 124. In the illustrated example, when storing the record of the advertisement request in the impression database 115, the example advertisement provider server 112 inspects the advertisement request to identify one or more device identifiers. Different device identifiers may be transmitted in different formats. For example, the UDID may be transmitted in a different portion, field, location, etc. of the advertisement request than the ADID. As such, multiple approaches to identifying different types of device identifiers included in the advertisement request messages may be employed. For example, the device identifier may be identified by inspecting a user identifier field in a header of an advertisement request (e.g., in a cookie field), and/or the device identifier may be identified by inspecting a body of the advertisement request. However, any other approach to identifying a device identifier may additionally or alternatively be used.

The example market column 136 of FIG. 1 identifies a geographic location (sometimes referred to as a market) of the mobile device 120, 122, 124 at the time of transmitting the advertisement request. In the illustrated example, when storing the record of the advertisement request in the impression database 115, the example advertisement provider server 112 determines the location of the mobile device 120, 122, 124 based on a header field in the request for the advertisement. In the illustrated example, the header field is a geolocation header. However any other header field may additionally or alternatively be used. In some examples, the example advertisement provider server 112 identifies the geographic location of the mobile device 120, 122, 124 by performing an Internet Protocol (IP) address to geographic location lookup. In the illustrated example of FIG. 1, the example market column 136 identifies a city and state (e.g., Chicago, Ill.; New York, N.Y.; etc.). However, any other approach to identifying a geographic location may additionally or alternatively be used such as, for example, global positioning system (GPS) coordinates, a street address, a zone improvement plan (ZIP) code, etc.

The example demographic segment column 137 of FIG. 1 identifies a demographic segment of the mobile device 120, 122, 124. In the illustrated example, when storing the record of the advertisement request in the impression database 115, the example advertisement provider server 112 determines the demographic segment of the mobile device 120, 122, 124 based on, for example, records of advertisements that have been requested by the mobile device 120, 122, 124. In examples disclosed herein demographic segments are identified using various demographic segmentation systems such as, for example, the PRIZM segmentation system and/or the ConneXions segmentation system, both of which are provided by The Nielsen Company (US), LLC. However any other approach to identifying a demographic segment may additionally or alternatively be used. In the illustrated example of FIG. 1, the example demographic segment column 137 identifies different demographic segments associated with each mobile device of the corresponding advertisement request. However, any other approach to identifying a demographic segment may additionally or alternatively be used.

The example timestamp column 138 of FIG. 1 identifies a time at which the record identifying the advertisement request was stored. In the illustrated example, when storing the record of the advertisement request in the impression database 115, the example advertisement provider server 112 determines a current time, and stores the current time in the timestamp column 138. However, the example advertisement provider server 112 may determine and/or store the time in any other fashion. For example, the example advertisement provider server 112 may identify a timestamp in the advertisement request, the example advertisement provider server 112 may determine a time at which the advertisement request was received, the example advertisement provider server 112 may determine a time at which a response to the advertisement request was provided to the requesting device, etc.

The example advertisement identifier column 139 of FIG. 1 identifies an advertisement associated with the record. In the illustrated example, when storing the record of the advertisement request in the impression database 115, the example advertisement provider server 112 determines an advertisement identifier (e.g., a serial identifier of the advertisement, a name of an advertisement, etc.) and stores the advertisement identifier in the advertisement identifier column 139. By storing the advertisement identifier in the advertisement identifier column 139, impression data can later be correlated to particular advertisements. In the illustrated example of FIG. 1, example advertisement identifiers stored in the example advertisement identifier column 139 are represented as numeric serial numbers. However, any other advertisement identifier format may additionally or alternatively be used. For example, the advertisement identifier(s) may be formatted using hexadecimal characters, text characters, etc.

As noted above, the example data table 130 of the illustrated example includes the first row 140, the second row 142, the third row 144, the fourth row 146, and the fifth row 148. In this example, the example first row 140 identifies that a request from a device having a device identifier of “0001,” which was manufactured by manufacturer A, was received while the identified device was located in Chicago, Ill. The example second row 142 identifies that a request from a device having a device identifier of “XABC5,” which was manufactured by manufacturer B, was received while the identified device was located in Chicago, Ill. The example third row 144 identifies that a request from a device having a device identifier of “98413A,” which was manufactured by manufacturer C, was received while the identified device was located in Chicago, Ill. The fourth row 146 identifies that a request from a device having a device identifier of “BEC836,” which was manufactured by manufacturer B, was received while the identified device was located in Chicago, Ill. The example fifth row 148 identifies that a request from a device having a device identifier of “1SVADB,” which was manufactured by manufacturer B, was received while the identified device was located in New York, N.Y.

The example data table 130 of FIG. 1 does not indicate whether the device identifiers correspond to the same device. For example, it is possible that the device identified by the second example row 142 (e.g., the device having an identifier of “XABC5”) is the same as the device identified by the fourth example row (e.g., the device having an identifier of “BEC836.) Without de-duplication, those different device would appear as if they represented two separate devices when, in fact, they represent the same device. As a result, over counting can occur.

In examples disclosed herein, the example mobile devices 120, 122, 124 are devices that transmit requests for advertisements. Commonly, mobile device applications (sometimes referred to as “apps”) and/or web pages displayed by mobile devices include advertisement banners. To retrieve the advertisement to be displayed in the advertisement banner, the mobile device 120, 122, 124 automatically transmits a request for the advertisement to the advertisement exchange 110. When transmitting the request for the advertisement, the mobile device 120, 122, 124 automatically includes a device identifier, such as a UDID, IDFA, ADID, etc. in the request. The device identifier enables the advertisement provider server 112 to select an advertisement that is appropriate for the user of the mobile device 120, 122, 124.

Many different makes and/or models of mobile devices exist. Different makes and/or models of mobile devices often use different types of device identifiers. In some examples, the mobile device 120, 122, 124 is associated with one or more device identifiers. In some examples, the device identifiers can be reset on the mobile device to, for example, clear a history of the mobile device. In the illustrated example of FIG. 1, three mobile devices 120, 122, 124 are shown. In practice, many different mobile devices are likely to be used in the environment such as, for example, an APPLE® iPhone®, a SAMSUNG™ Galaxy S4™, etc.

In examples disclosed herein, the advertisement exchange 110 communicates with the mobile device 120, 122, 124 via the telecommunications provider network 125. The telecommunications provider network 125 is operated by a telecommunications services provider (e.g., an Internet Service Provider (ISP)). In the illustrated example, of FIG. 1, the telecommunications provider network 125 facilitates communications via the Internet 126. While in the illustrated example, the mobile device(s) 120, 122, 124 communicate with the advertisement exchange 110 via the Internet 126, any other type(s) and/or number(s) of networks (e.g., the telecommunications provider network 125, a local area network (LAN), a wide area network (WAN), etc.) may additionally or alternatively be used to facilitate communication among the advertisement exchange 110 and the example mobile device(s) 120, 122, 124. For example, a local area network (LAN), a wide area network (WAN), a virtual private network (VPN), etc. may be present and employed to facilitate communication to and/or from the Internet 126.

The example market share estimation server 105 of the illustrated example includes an example impression data accesser 150, an example result parser 160, an example ratio processor 165, an example ratio database 170, an example demographic database 171, and an example reporter 175.

The example impression data accesser 150 of the illustrated example of FIG. 1 accesses impression data stored in the impression database 115. In the illustrated example, the impression data accesser 150 accesses the impression data by transmitting a request 151 for impression data to the advertisement exchange 110 and receiving a response 152 to the request. The example impression data accesser 150 of FIG. 1 then forwards the received impression data to the example result parser 160.

In the illustrated example and as shown in FIG. 1, the example impression data accesser 150 communicates with the advertisement exchange 110 via the Internet 126. However, the example impression data accesser 150 may communicate with the example advertisement exchange 110 in any other fashion. For example, the example impression data accesser 150 may communicate with the advertisement exchange 110 via a private network, or a virtual private network (VPN), the example impression data accesser 150 may communicate with the example advertisement exchange via a local physical connection (e.g., a serial or universal serial bus (USB) connection), etc.

In examples disclosed herein, the example impression data accesser 150 requests impression data from the example advertisement exchange 110. In response to the request, the example advertisement provider server 112 of the example advertisement exchange 110 provides impression data (e.g., impression data stored in the example impression database 110). However, in some examples, the example advertisement provider server 112 of the example advertisement exchange 110 may provide the impression data to the example impression data accesser 150 without having first received a request. For example, the example advertisement exchange 110 may periodically and/or a-periodically provide (e.g., push) impression data to the impression data accesser 150.

The example result parser 160 of FIG. 1 parses the impression data received by the example impression data accesser 150 to determine a total number of unique device identifiers associated with a manufacturer. In some examples, the example result parser 160 parses the impression data to identify unique device identifiers associated with a manufacturer that were used in a particular geographic region and/or time period (e.g., via the example market column 136 and/or the example timestamp column 138.) As noted above, whereas a manufacturer of the mobile device is identified in the illustrated example, any other parameter(s) and/or characteristic(s) of the mobile device (e.g., a model of the mobile device, a version number of the model device, etc.) may additionally or alternatively be used.

In the illustrated example, the example result parser 160 parses the impression data using structured query language (SQL) commands. For example, the example result parser 160 of FIG. 1 performs a “select unique” command against the impression data to identify unique device identifiers, and/or performs a “count” command to identify a number of unique device identifiers. In some examples, additional parameters such as, for example, a geographic location, a model of the mobile device, etc. are used when performing the queries to identify unique device identifiers and/or a count of those unique device identifiers that have matching parameters. However, any other approach to identifying unique device identifiers may additionally or alternatively be used.

The example ratio processor 165 of FIG. 1 calculates a de-duplication ratio to be applied to the count of unique device identifiers to identify an estimated number of unique devices. In the illustrated example, the de-duplication ratio is calculated on a per-manufacturer basis. However, when a market share is estimated based on a different mobile device parameter and/or characteristic (e.g., a model of the mobile device, a version number of the mobile device), the de-duplication ratio may be calculated on a per-parameter and/or per-characteristic basis (e.g., a per-model basis, a per-version basis, etc.).

In the example of FIG. 1, the example ratio is calculated by dividing a total number of mobile devices associated with a manufacturer known to be in use in a geographic region by a number of unique device identifiers associated with a manufacturer that region. In examples disclosed herein, the total number of mobile devices associated with the manufacturer known to be in use in the geographic region is identified by accessing a report from a telecommunications service provider representing current mobile devices in use on the telecommunications provider network. For example, if ten thousand devices produced by manufacturer A were known to be in use within a first geographic region, and twenty thousand unique device identifiers were identified in the first geographic region in association with manufacturer A, the resulting de-duplication ratio would be one half (e.g., ten thousand divided by twenty thousand). The example ratio processor 165 can then apply the calculated de-duplication ratio to unique identifier data from a second geographic region to estimate the number of mobile devices produced by the manufacturer in the second geographic region.

In the illustrated example, the example ratio processor 165 determines the known number of mobile devices produced by a manufacturer and in use in a geographic region by communicating with a telecommunications network provider to determine how many devices produced by a manufacturer are in use on the telecommunications network. For example, the example ratio processor 165 may utilize techniques disclosed in Frangione, U.S. Pat. No. 6,516,189, and/or Lin, U.S. Patent Publication No. 2013/0060608, to request that the telecommunications network provider inspect a home location register (HLR) of the telecommunications network to identify mobile devices in use on the telecommunication provider network. U.S. Pat. No. 6,516,189 and U.S. Patent Publication No. 2013/0060608 are hereby incorporated by reference herein in their entirety.

Using information provided by the telecommunications network provider alone to estimate market share is not feasible because, for example, multiple telecommunications network providers exist (thereby requiring multiple requests for information concerning devices in use on the telecommunications network), not all telecommunications network providers operate in all geographic regions, not all telecommunications network providers will provide their data, etc. Moreover, such reports may be computationally expensive and/or take a long time to create. Using the de-duplication approach disclosed herein to estimate market share based on advertisement impression data reduces the computation requirements of preparing such a telecommunications network usage report (e.g., reduces the load on a central processing unit, thereby freeing the device for other operations). Moreover, reports of estimated mobile device market share can quickly be prepared, as records of advertisement impressions are readily available and de-duplication ratios do not change frequently.

In the illustrated example, to determine the estimated market share, the example ratio processor 165 applies the calculated de-duplication ratio to the number of unique device identifiers identified by the example result parser 160. In the illustrated example, the example ratio processor 165 multiples the calculated de-duplication ratio by the number of unique device identifiers. The product of this mathematical operation is the estimated number of devices actually in use in the market. However, any other mathematical operation may additionally or alternatively be used.

In the illustrated example, the example ratio processor 165 calculates the de-duplication ratio on a periodic basis (e.g., weekly, monthly, yearly, etc.). Periodically re-calculating the de-duplication ratio enables the ratio processor 165 to account for changes in how different manufacturers, mobile device models, mobile device versions, etc. handle device identifiers (e.g., new device identifiers may be adopted, old device identifiers may no longer be used, etc.).

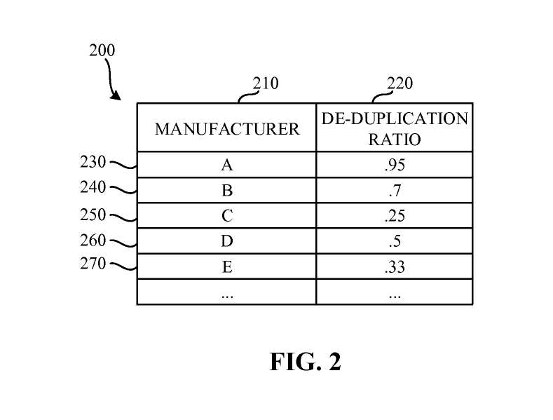

In the illustrated example, the example ratio database 170 stores the de-duplication ratio(s) calculated by the example ratio processor 165 for corresponding manufacturers. An example data table 200 representing data stored in the example ratio database is disclosed in connection with FIG. 2. The example ratio database 170 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example ratio database 170 may additionally or alternatively be implemented by one or more double data rate (DDR) memories, such as DDR, DDR2, DDR3, mobile DDR (mDDR), etc. The example ratio database 170 may additionally or alternatively be implemented by one or more mass storage devices such as hard drive disk(s), compact disk drive(s), digital versatile disk drive(s), etc. While the illustrated example ratio database 170 is illustrated as a single database, the example ratio database 170 may be implemented by any number and/or type(s) of databases.

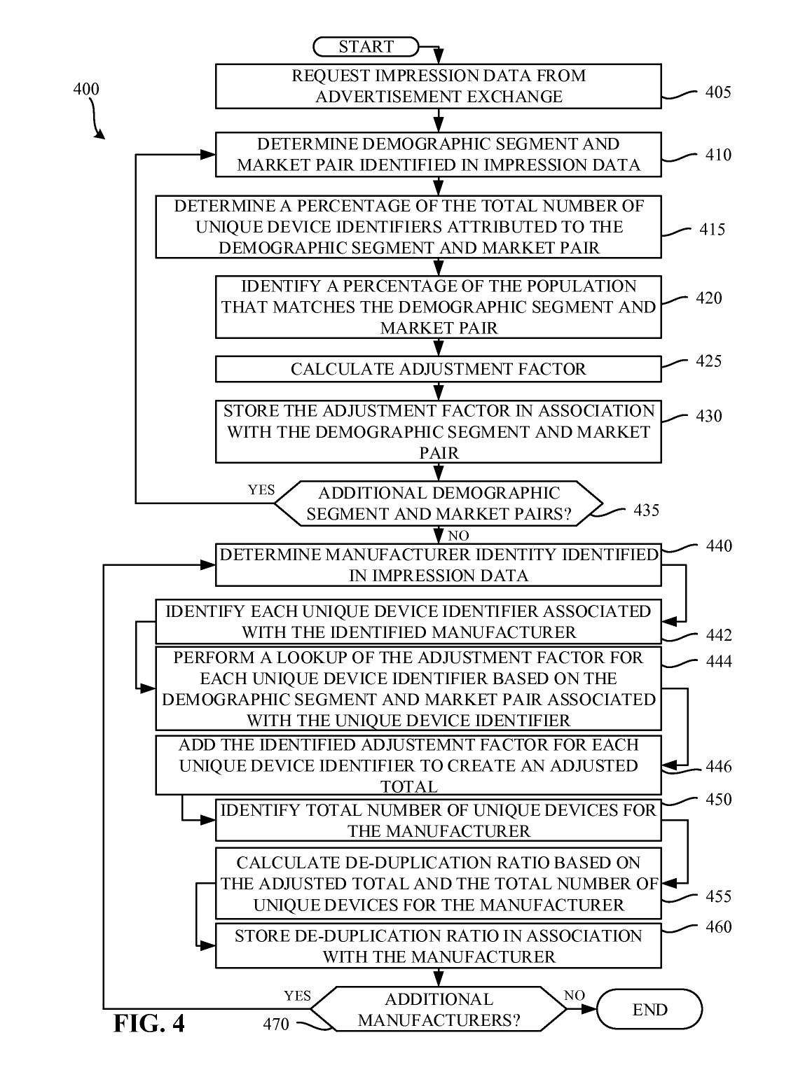

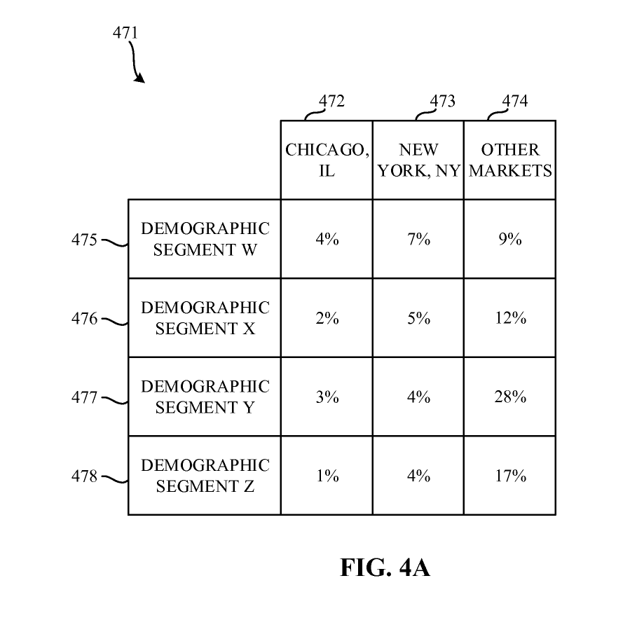

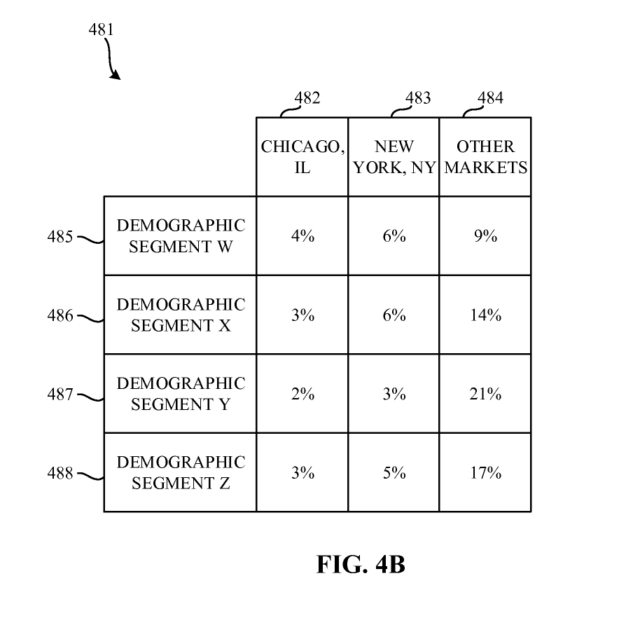

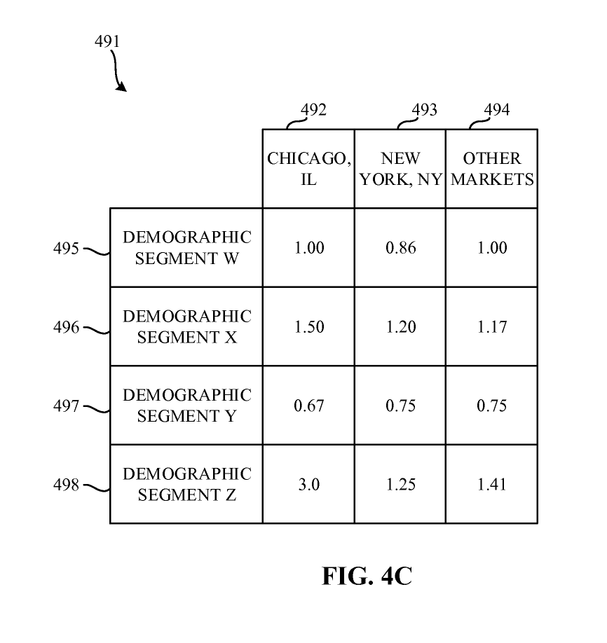

In the illustrated example, the example demographic database 171 stores information corresponding to demographic segment and market pairs. An example data table 481 representing data stored in the example demographic database 171 is disclosed in connection with FIG. 4B. For example, the example data table 481 of FIG. 4B illustrates a population distribution among different demographic segment and market pairs. The example demographic database 171 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example demographic database 171 may additionally or alternatively be implemented by one or more double data rate (DDR) memories, such as DDR, DDR2, DDR3, mobile DDR (mDDR), etc. The example demographic database 171 may additionally or alternatively be implemented by one or more mass storage devices such as hard drive disk(s), compact disk drive(s), digital versatile disk drive(s), etc. While the illustrated example demographic database 171 is illustrated as a single database, the example demographic database 171 may be implemented by any number and/or type(s) of databases.

While the example demographic database 171 is illustrated as a part of the market share estimation server, the example demographic database 171 may be implemented external to the market share estimation server 105. For example, the example demographic database 171 may be hosted by a separate server operated by the monitoring entity operating the market share estimation server 105. Moreover, the example demographic database 171 may be hosted by an entity other than the entity operating the market share estimation server.

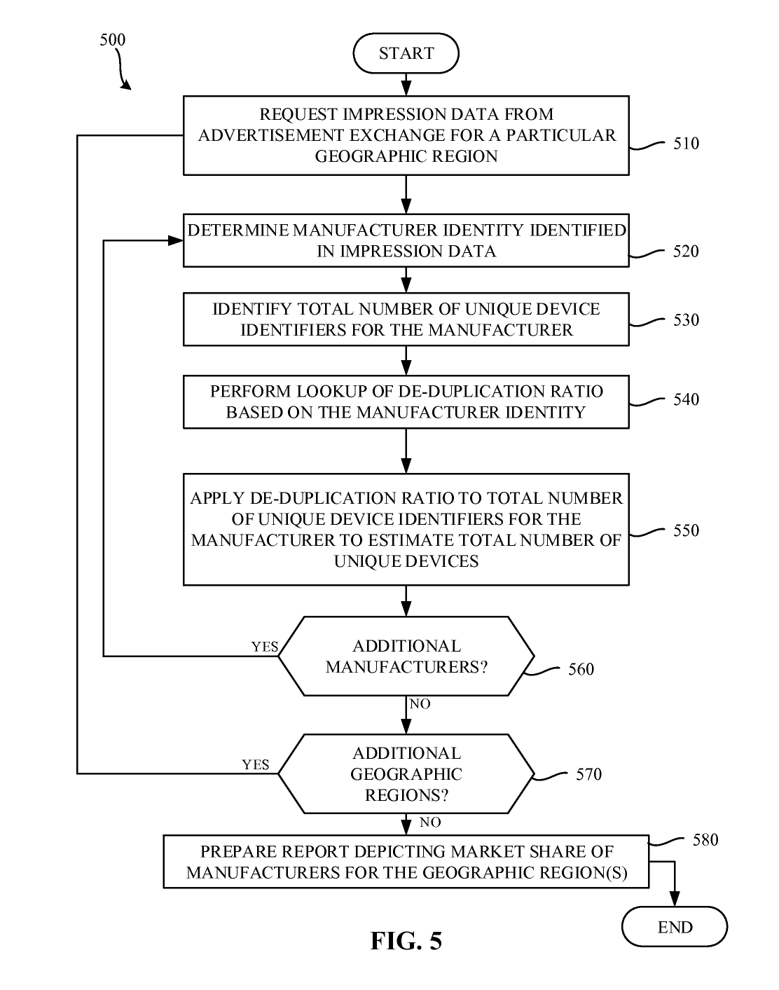

The example reporter 175 of the illustrated example of FIG. 1 generates one or more reports identifying market share(s) of various mobile devices and/or manufacturers of mobile devices based on the estimated number of mobile devices. In some examples, the market share reports present breakdown(s) according to different mobile device parameters such as, for example a mobile device model, a mobile device version number, etc. In some examples, the market share reports illustrate market shares associated with different geographic regions. An example market share report is shown in the illustrated example of FIG. 5.

The example data table 200 of FIG. 2 indicates de-duplication ratios in association with respective mobile device manufacturers. The example data table 200 of the illustrated example of FIG. 2 includes a manufacturer column 210 and a de-duplication ratio column 220. The example manufacturer column 210 identifies a manufacturer. In the illustrated example of FIG. 2, example manufacturers are identified by a character (e.g., “A,” “B,” “C,” etc.). However, manufacturers may be identified in any other fashion such as, for example, by an alphanumeric string, a name of the manufacturer, etc. The example de-duplication ratio column 220 identifies de-duplication ratios calculated for the manufacturer identified by the example manufacturer column 210 in the corresponding row. De-duplication ratios closer to one than to zero indicate that there is little duplication of device identifiers used by a single device (e.g., the mobile device tends to use only a single unique device identifier). De-duplication ratios closer to zero than to one indicate that there is a greater degree of duplication of device identifiers used by a single device (e.g., the mobile device tends to use more than one unique device identifier).

The example data table 200 of the illustrated example of FIG. 2 includes a first example row 230, a second example row 240, a third example row 250, a fourth example row 260, and a fifth example row 270. The first example row 230 identifies that a de-duplication ratio of “0.95” was calculated in association with manufacturer “A.” The second example row 240 identifies that a de-duplication ratio of “0.7” was calculated in association with manufacturer “B.” The third example row 250 identifies that a de-duplication ratio of “0.25” was calculated in association with manufacturer “C.” The fourth example row 260 identifies that a de-duplication ratio of “0.5” was calculated in association with manufacturer “D.” The fifth example row 270 identifies that a de-duplication ratio of “0.33” was calculated in association with manufacturer “E.”

While an example manner of implementing the market share estimation server 105 of FIG. 1 is illustrated in FIG. 1, one or more of the elements, processes and/or devices illustrated in FIG. 1 may be combined, divided, re-arranged, omitted, eliminated and/or implemented in any other way. Further, the example impression data accesser 150, the example result parser 160, the example ratio processor 165, the example ratio database 170, the example demographic database 171, the example reporter 175, and/or, more generally, the example market share estimation server 105 of FIG. 1 may be implemented by hardware, software, firmware and/or any combination of hardware, software and/or firmware. Thus, for example, any of the example impression data accesser 150, the example result parser 160, the example ratio processor 165, the example ratio database 170, the example demographic database 171, the example reporter 175, and/or, more generally, the example market share estimation server 105 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example impression data accesser 150, the example result parser 160, the example ratio processor 165, the example ratio database 170, the example demographic database 171, the example reporter 175, and/or, more generally, the example market share estimation server 105 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example market share estimation server 105 of FIG. 1 may include one or more elements, processes and/or devices in addition to, or instead of, those illustrated in FIG. 1, and/or may include more than one of any or all of the illustrated elements, processes and devices.

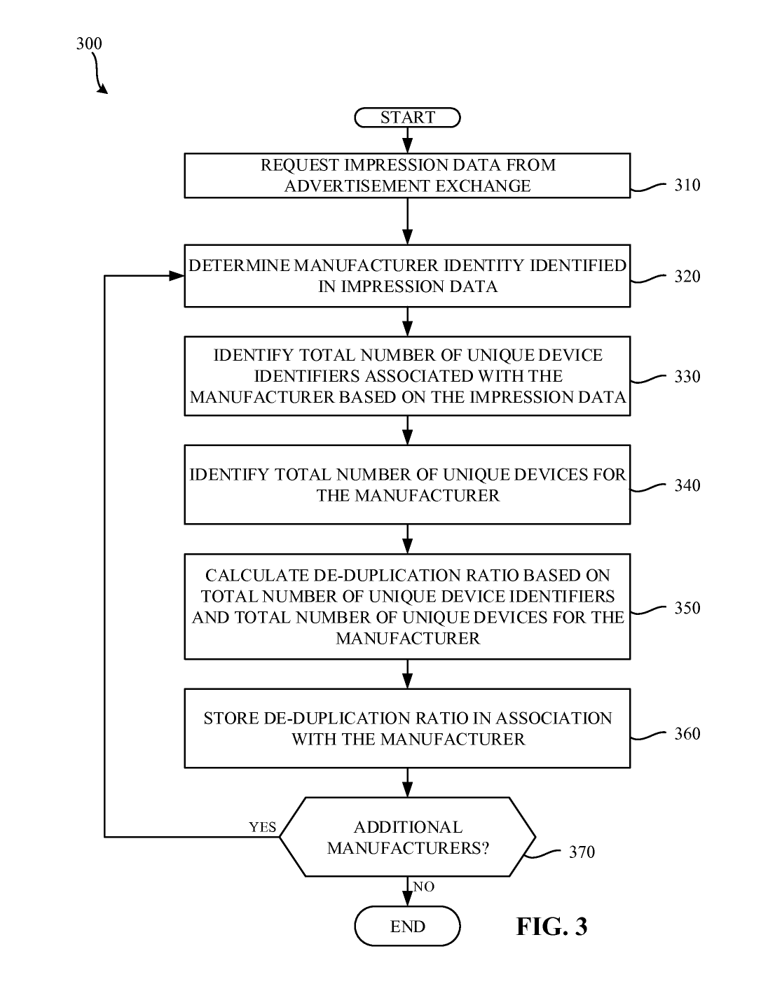

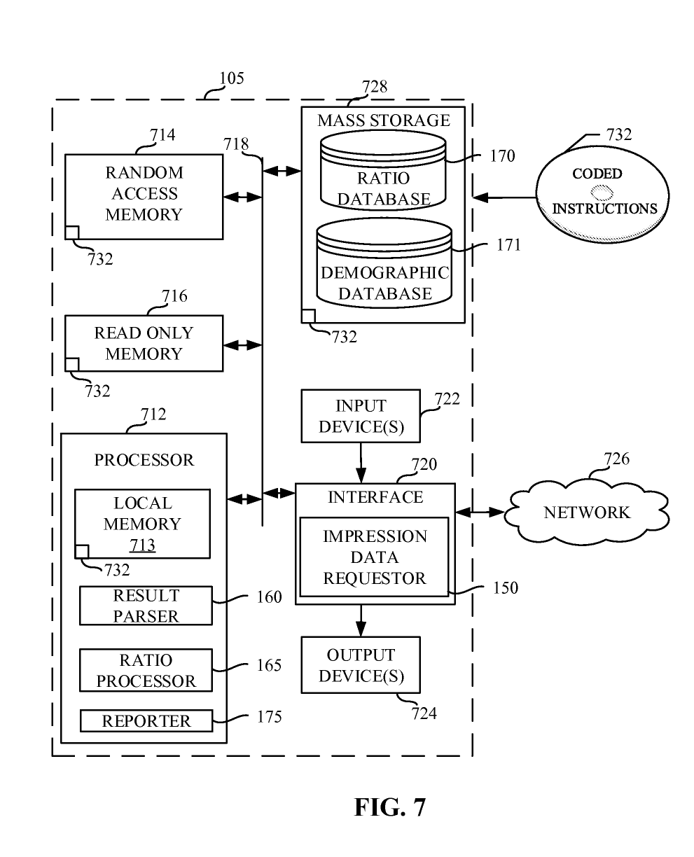

Flowcharts representative of example machine readable instructions for implementing the example market share estimation server 105 of FIG. 1 are shown in FIGS. 3, 4, and/or 5. In these examples, the machine readable instructions comprise a program(s) for execution by a processor such as the processor 712 shown in the example processor platform 700 discussed below in connection with FIG. 7. The program may be embodied in software stored on a tangible computer readable storage medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIGS. 3 and/or 4, many other methods of implementing the example market share estimation server 105 may alternatively be used. For example, the order of execution of the blocks may be changed, and/or some of the blocks described may be changed, eliminated, or combined.

As mentioned above, the example processes of FIGS. 3 and/or 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 3 and/or 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended. As used herein, “including” and other forms of includes are open ended (i.e., not closed) terms. Thus, a list or claim of one or more elements introduced by a form of “include” or a form of “comprise” may include more than the listed element(s).

FIG. 3 is a flow diagram representative of example machine-readable instructions 300 that may be executed to implement the example market share estimation server 105 of FIG. 1 to determine de-duplication ratios for respective mobile device manufacturers. The example process of FIG. 3 begins when the example impression data accesser 150 requests impression data from the advertisement exchange 110. (Block 310). In the illustrated example, the request for impression data is limited to a particular geographic region. However, in some examples, a geographic restriction may not be utilized. Restricting the impression data to a particular region is useful because it results in a more accurate de-duplication ratio when the total number of unique devices is also limited to that same geographic region. For example, the de-duplication ratio may be inaccurate for a specific region if the impression data represents a first geographic region and the known number of unique devices represents a second geographic region different from the first geographic region.

The example result parser 160 parses the impression data received from the example impression database 115 of the example advertisement exchange 110 to determine a manufacturer identity included in the impression data. (Block 320). The example impression data may be formatted in a manner similar to the example impression data shown in the example data table 130 of the illustrated example of FIG. 1. The example result parser 160 determines the manufacturer identity by creating a list of unique manufacturers identified in the impression data and selecting one of those unique manufacturers for calculation of a respective de-duplication ratio. Successive manufacturers may later be selected for calculation of their respective de-duplication ratio. While a serial approach to calculating the ratio(s) is used in this example, any other approach may additionally or alternatively be used. For example, de-duplication ratios for multiple manufacturers may be calculated in parallel. Additionally or alternatively, the request for impression data of Block 310 may be specific to a particular manufacturer such that identification of the unique device identifiers associated with the manufacturer is performed by virtue of the request for the impression data (e.g., only data pertaining to a particular manufacturer is returned by the advertisement provider server 112).

The example result parser 160 identifies a total number of unique device identifiers associated with the manufacturer. (Block 330). In the illustrated example, the result parser 160 identifies the total number of unique device identifiers by counting the number of unique identifiers of the impression data having a manufacturer identity matching the manufacturer identity determined in Block 320. However, any other approach to identifying a total number of unique device identifiers associated with a particular manufacturer may additionally or alternatively be used. For example, the example result parser 160 may utilize a structured query language (SQL) count command to determine a count of the unique device identifiers.

The example ratio processor 165 of FIG. 1 identifies a total number of unique devices associated with the manufacturer (and/or associated with the geographic region represented by the impression data). (Block 340). In the illustrated example, the total number of unique devices is identified by accessing a report from a telecommunications service provider representing current mobile devices in use on the telecommunications provider network. However, any other approach to identifying a total number of unique devices associated with the manufacturer may additionally or alternatively be used. For example, the ratio processor 165 may identify the total number of unique devices based on sales information (e.g., retail sales information), survey responses, etc.

Using the total number of unique devices associated with a manufacture (and/or geographic region) identified in Block 340 and the total number of unique device identifiers associated with the manufacturer (and/or the geographic region), the example ratio processor 165 of FIG. 1 calculates a de-duplication ratio for the manufacturer. (Block 350). In the illustrated example, the de-duplication ratio is calculated by dividing the total number of unique devices in use for that manufacturer in the area in question by the total number of unique device identifiers for that same manufacturer. However, any other approach to calculating the de-duplication ratio may additionally or alternatively be used.

The example ratio processor 165 stores, in the ratio database 170, the calculated de-duplication ratio in association with the identity of the manufacturer. (Block 360). The example data table 200 of FIG. 2 represents example de-duplication ratio(s) stored in association with their respective manufacturer. In some examples, the example ratio processor 165 stores additional information in association with the de-duplication ratio and manufacturer. For example, a timestamp may be stored indicating when the de-duplication ratio was calculated. In some examples, the de-duplication ratio may be periodically re-calculated. Storing a timestamp facilitates identification of the time and/or date at which the ratio was calculated and, thus, assists in determining when the recalculation of the de-duplication ratio should occur. Moreover, in some examples, the ratio processor 165 may additionally store location information identifying a geographic region that was used when calculating the de-duplication ratio.

The example ratio processor 165 determines whether any additional manufacturers for which de-duplication ratios have not yet been calculated are identified in the impression data. (Block 370). If additional manufacturers are identified in the impression data and de-duplication ratios are to be calculated for these manufacturers (Block 370 returns a result of YES), control returns to Block 320 where the next manufacturer is identified or, if the next manufacturer is already known at Block 370, control returns to Block 330 (i.e., Block 320 is skipped). The example process of Block 320 (or Block 330) through Block 370 is repeated until de-duplication ratios for all manufacturers identified in the impression data who are of interest are calculated. In some examples, de-duplication ratios are calculated only for certain manufacturers. For example, de-duplication ratios may be calculated for the top ten manufacturers by number of unique devices, may be calculated for a pre-defined list of manufacturers, may be calculated for manufacturers having more than a threshold number of entries in the data set, etc.

If no additional manufacturers are identified for de-duplication processing (i.e., no more de-duplication ratios are to be calculated such that Block 370 returns a result of NO), the example process 300 of FIG. 3 terminates. The example process 300 of FIG. 3 may be repeated periodically and/or a-periodically. For example, the example process 300 of FIG. 3 may be repeated on a monthly basis, on a weekly basis, on demand, etc.

FIG. 4 is a flow diagram representative of example machine-readable instructions 400 that may be executed to implement the example market share estimation server 105 of FIG. 1 to determine demographically weighted de-duplication ratios for respective mobile device manufacturers. In some examples, the de-duplication ratio is calculated based on demographically weighted totals to ensure that the de-duplication ratio does not mis-estimate a number of mobile devices because of a particular demographic being dis-proportionately represented in the impression data.

The example process of FIG. 4 begins when the example impression data accesser 150 requests impression data from the advertisement exchange 110. (Block 405). In the illustrated example, the request for impression data is limited to a particular geographic region (e.g., a nation). However, in some examples, a geographic restriction may not be utilized. Restricting the impression data to a particular region is useful because it results in a more accurate de-duplication ratio when the total number of unique devices is also limited to that same geographic region. For example, the de-duplication ratio may be inaccurate for a specific region if the impression data represents a first geographic region and the known number of unique devices represents a second geographic region different from the first geographic region.

The example result parser 160 parses the impression data received from the example impression database 115 of the example advertisement exchange 110 to determine a demographic segment and market pair identified in the impression data. (Block 410). For example, with reference to the example data table 130 of FIG. 1, the example result parser 160 identifies the demographic segment and market pair based on the example market column 136 and the example demographic segment column 137. The example impression data may be formatted in a manner similar to the example impression data shown in the example data table 130 of the illustrated example of FIG. 1. The example result parser 160 determines the demographic segment and market pair by creating a list of unique demographic segment and market pairs identified in the impression data and selecting one of those unique demographic segments for calculation of a respective adjustment factor. However, any other approach to determining an identity of a demographic segment and market pair may additionally or alternatively be used.

The example result parser 160 determines a percentage of the total number of unique device identifiers attributed to the identified demographic segment and market pair. (Block 415). In the illustrated example, the result parser 160 identifies the percentage of the total number of unique device identifiers by counting the number of records of the impression data having a unique device identifier and a demographic segment and market pair matching the demographic segment and market pair determined in Block 410, and dividing the counted number of records by the total number of unique device identifiers of the impression data. However, any other approach to determining the percentage of the total number of unique device identifiers attributed to the demographic segment and market pair may additionally or alternatively be used. Moreover, approaches other than a percentage based approach may additionally or alternatively be used. For example, the total number of unique device identifiers matching the demographic segment and market pair may be identified. An example table 471 representing percentage(s) of impressions attributed to different demographic segment and market pairs is shown in the illustrated example of FIG. 4A.

The example data table 471 of the illustrated example of FIG. 4A includes columns representative of corresponding markets, and includes rows representative of corresponding demographic segments. Values in each cell of the example data table 471 of FIG. 4A represent a percentage of the records of the impression data attributable to the corresponding demographic segment and market pair. While in the illustrated example, the demographic segments are represented using rows and markets are represented using columns, any other approach to representing demographic segment and market pairs may additionally or alternatively be used. In the illustrated example of FIG. 4A, the cells are represented using a percentage. As such, the sum of the values of the cells equals one hundred percent. However, any other approach to representing a distribution of demographic segment and market pairs may additionally or alternatively be used.

The example data table 471 of the illustrated example of FIG. 4A includes a first market column 472, a second market column 473, and a third market column 474. The example first market column 472 corresponds to the Chicago, Ill. market. The example second market column 473 corresponds to the New York, N.Y. market. The example third market column 473 is a wildcard market and accounts for all markets not identified by either the example first market column 472 or the example second market column 473. While two markets and one wildcard market are represented in the illustrated example of FIG. 4A, any number of markets may additionally or alternatively be identified. For example, fifty separate markets corresponding to different metropolitan markets, states, etc. may be represented.

The example data table 471 of the illustrated example of FIG. 4A includes a first demographic segment row 475, a second demographic segment row 476, a third demographic segment row 477, and a fourth demographic segment row 478. The example demographic segment rows correspond to demographic segments identified using a demographic segmentation system such as, for example, the PRIZM segmentation system and/or the ConneXions segmentation system, both of which are provided by The Nielsen Company (US), LLC. However any other approach to identifying a demographic segment may additionally or alternatively be used. In the illustrated example of FIG. 4A, four demographic segments are represented by the example rows 475, 476, 477, 478. However, any number of rows may additionally or alternatively be used such as, for example, ten rows, fifty rows, etc.

Returning to the example process 400 of FIG. 4, the example ratio processor 165 of FIG. 1 identifies an estimated number of persons within the identified demographic segment and market pair. (Block 415). In the illustrated example, the estimated number of persons within the demographic segment and market pair is identified by consulting the demographic database 171. In examples disclosed herein, the example demographic database 171 is queried to identify an estimated percentage of persons within the identified demographic segment and market pair. However, any other approach to identifying an estimated percentage of persons within a demographic segment may additionally or alternatively be used. For example, a count of the number of persons within the identified demographic segment and market pair may be used. An example table 481 representing percentage(s) of the population attributed to different demographic segment and market pairs is shown in the illustrated example of FIG. 4B.

The example data table 481 of the illustrated example of FIG. 4B includes columns representative of corresponding markets, and includes rows representative of corresponding demographic segments. Values in each cell of the example data table 481 of FIG. 4B represent a percentage of the population attributable to the corresponding demographic segment and market pair. While in the illustrated example, the demographic segments are represented using rows and markets are represented using columns, any other approach to representing demographic segment and market pairs may additionally or alternatively be used. In the illustrated example of FIG. 4B, the cells are represented using a percentage. As such, the sum of the values of the cells equals one hundred percent. However, any other approach to representing a distribution of demographic segment and market pairs may additionally or alternatively be used.

The example data table 481 of the illustrated example of FIG. 4B includes a first market column 482, a second market column 483, and a third market column 484. The example first market column 482 corresponds to the Chicago, Ill. market. The example second market column 483 corresponds to the New York, N.Y. market. The example third market column 483 is a wildcard market and accounts for all markets not identified by either the example first market column 482 or the example second market column 483. While two markets and one wildcard market are represented in the illustrated example of FIG. 4B, any number of markets may additionally or alternatively be identified. For example, fifty separate markets corresponding to different metropolitan markets, states, etc. may be represented.

The example data table 481 of the illustrated example of FIG. 4B includes a first demographic segment row 485, a second demographic segment row 486, a third demographic segment row 487, and a fourth demographic segment row 488. The example demographic segment rows correspond to demographic segments identified using a demographic segmentation system such as, for example, the PRIZM segmentation system and/or the ConneXions segmentation system, both of which are provided by The Nielsen Company (US), LLC. However any other approach to identifying a demographic segment may additionally or alternatively be used. In the illustrated example of FIG. 4B, four demographic segments are represented by the example rows 485, 486, 487, 488. However, any number of rows may additionally or alternatively be used such as, for example, ten rows, fifty rows, etc.

Returning to the example process 400 of FIG. 4, the example ratio processor 165 calculates an adjustment factor. (Block 425). In the illustrated example, the adjustment factor is calculated by dividing the percentage of the total number of unique device identifiers attributed to the demographic segment and market pair (identified in Block 415) by the percentage of the population matching the demographic segment and market pair (identified in Block 420). However, any other approach to calculating the adjustment factor may additionally or alternatively be used. The example ratio processor 165 then stores the calculated adjustment factor in the ratio database 170. (Block 430). The example ratio processor 165 determines whether adjustment factors for additional demographic segment and market pairs are to be calculated. (Block 435). The example process of Blocks 410 through 435 is repeated until adjustment factors corresponding to each identified demographic segment and market pair are calculated and stored. An example data table 491 representing calculated adjustment factors corresponding to different demographic segment and market pairs is shown in the illustrated example of FIG. 4C.

The example data table 491 of the illustrated example of FIG. 4C includes columns representative of corresponding markets, and includes rows representative of corresponding demographic segments. Values in each cell of the example data table 491 of FIG. 4C represent the calculated adjustment factor for the corresponding demographic segment and market pair. While in the illustrated example, the demographic segments are represented using rows, and markets are represented using columns, any other approach to representing demographic segment and market pairs may additionally or alternatively be used. In the illustrated example of FIG. 4C, the cells are represented using a decimal number. However, any other approach to representing adjustment factor(s) of demographic segment and market pairs may additionally or alternatively be used such as, for example, integer numbers, hexadecimal values, etc.

The example data table 491 of the illustrated example of FIG. 4C includes a first market column 492, a second market column 493, and a third market column 494. The example first market column 492 corresponds to the Chicago, Ill. market. The example second market column 493 corresponds to the New York, N.Y. market. The example third market column 493 is a wildcard market and accounts for all markets not identified by either the example first market column 492 or the example second market column 493. While two markets and one wildcard market are represented in the illustrated example of FIG. 4C, any number of markets may additionally or alternatively be identified. For example, fifty separate markets corresponding to different metropolitan markets, states, etc. may be represented.

The example data table 491 of the illustrated example of FIG. 4C includes a first demographic segment row 495, a second demographic segment row 496, a third demographic segment row 497, and a fourth demographic segment row 498. The example demographic segment rows correspond to demographic segments identified using a demographic segmentation system such as, for example, the PRIZM segmentation system and/or the ConneXions segmentation system, both of which are provided by The Nielsen Company (US), LLC. However any other approach to identifying a demographic segment may additionally or alternatively be used. In the illustrated example of FIG. 4C, four demographic segments are represented by the example rows 495, 496, 497, 498. However, any number of rows may additionally or alternatively be used such as, for example, ten rows, fifty rows, etc.

Once adjustment factors have been calculated for each demographic segment and market pair (Block 435 returns a result of NO), the example result parser 160 parses the impression data received from the example impression database 115 of the example advertisement exchange 110 to determine a manufacturer identity included in the impression data. (Block 440). The example impression data may be formatted in a manner similar to the example impression data shown in the example data table 130 of the illustrated example of FIG. 1. The example result parser 160 determines the manufacturer identity by creating a list of unique manufacturers identified in the impression data and selecting one of those unique manufacturers for calculation of a respective de-duplication ratio. Successive manufacturers may later be selected for calculation of their respective de-duplication ratio. While a serial approach to calculating the ratios is used in this example, any other approach may additionally or alternatively be used. For example, de-duplication ratios for multiple manufacturers may be calculated in parallel. Additionally or alternatively, the request for impression data of Block 405 may be specific to a particular manufacturer such that identification of the unique device identifiers associated with the manufacturer is performed by virtue of the request for the impression data (e.g., only data pertaining to a particular manufacturer is returned by the advertisement provider server 112).

The example ratio processor 165 identifies each unique device identifier associated with the manufacturer from the impression data. (Block 442). The example ratio processor 165 performs a lookup of the adjustment factor for the demographic segment and market pair identified in association with each identified unique device identifier (e.g., the adjustment factors stored in association with Block 430). (Block 444). The identified adjustment factor associated with each unique device identifier are then added to create an adjusted total number of unique device identifiers. (Block 446).

The example ratio processor 165 of FIG. 1 identifies a total number of unique devices associated with the manufacturer (and/or associated with the geographic region represented by the impression data). (Block 450). In the illustrated example, the total number of unique devices is identified by accessing a report from a telecommunications service provider representing current mobile devices in use on the telecommunications provider network. However, any other approach to identifying a total number of unique devices associated with the manufacturer may additionally or alternatively be used. For example, the ratio processor 165 may identify the total number of unique devices based on sales information (e.g., retail sales information), survey responses, etc.

Using the total number of unique devices associated with a manufacture (and/or geographic region) identified in Block 450 and the adjusted total number of unique device identifiers associated with the manufacturer (and/or the geographic region), the example ratio processor 165 of FIG. 1 calculates a de-duplication ratio for the manufacturer. (Block 455). In the illustrated example, the de-duplication ratio is calculated by dividing the total number of unique devices in use for that manufacturer in the area in question by the adjusted total number of unique device identifiers for that same manufacturer. However, any other approach to calculating the de-duplication ratio may additionally or alternatively be used.

The example ratio processor 165 stores, in the ratio database 170, the calculated de-duplication ratio in association with the identity of the manufacturer. (Block 460). The example data table 200 of FIG. 2 represents example de-duplication ratio(s) stored in association with their respective manufacturer. In some examples, the example ratio processor 165 stores additional information in association with the de-duplication ratio and manufacturer. For example, a timestamp may be stored indicating when the de-duplication ratio was calculated. In some examples, the de-duplication ratio may be periodically re-calculated. Storing a timestamp facilitates identification of the time and/or date at which the ratio was calculated and, thus, assists in determining when the recalculation of the de-duplication ratio should occur. Moreover, in some examples, the ratio processor 165 may additionally store location information identifying a geographic region that was used when calculating the de-duplication ratio.

The example ratio processor 165 determines whether any additional manufacturers for which de-duplication ratios have not yet been calculated are identified in the impression data. (Block 470). If additional manufacturers are identified in the impression data and de-duplications ratios are to be calculated for those manufacturers, (Block 470 returns a result of YES), control returns to Block 440 where the next manufacturer is identified or, if the next manufacturer is already known at block 440, control returns to block 442 (i.e., block 440 is skipped). The example process of Block 440 through Block 470 is repeated until de-duplication ratios for all manufacturers identified in the impression data who are of interest are calculated. In some examples, de-duplication ratios are calculated only for certain manufacturers. For example, de-duplication ratios may be calculated for the top ten manufacturers by number of unique devices, may be calculated for a pre-defined list of manufacturers, may be calculated for manufacturers having more than a threshold number of entries in the data set, etc.

If no additional manufacturers are identified for de-duplication processing (i.e., no more de-duplication ratios are to be calculated such that Block 470 returns a result of NO), the example process 400 of FIG. 4 terminates. The example process 400 of FIG. 4 may be repeated periodically and/or a-periodically. For example, the example process 400 of FIG. 4 may be repeated on a monthly basis, on a weekly basis, on demand, etc.

FIG. 5 is a flow diagram representative of example machine-readable instructions 500 that may be executed to implement the example market share estimation server 105 of FIG. 1 to prepare a market share report. The example process 500 of FIG. 5 begins when the example impression data accesser 150 requests impression data from the advertisement exchange in association with a particular geographic region. (Block 510). In the illustrated example, the geographic region used in Block 510 is different from the geographic region used when calculating the de-duplication ratio in association with FIGS. 3 and/or 4. For example, whereas the de-duplication ratio may be calculated with respect to a first region, the impression data may be requested for a second region different from the first region (e.g., a city within the national region, a different national region, etc.) to facilitate creation of the market share report for the second geographic region.

The example result parser 160 determines a manufacturer identified in the impression data. (Block 520). In the illustrated example, the example result parser 160 determines the identity of the manufacturer by selecting a unique manufacturer identifier included in the accessed impression data for application of a de-duplication ratio associated with that manufacturer. In examples disclosed herein, successive manufacturers are sequentially selected for application of their respective de-duplication ratio. While the example of FIG. 5 shows de-duplication performed in a serial fashion (i.e., one manufacturer after another), any other approach to de-duplication may additionally or alternatively be used. For example, de-duplication ratio(s) associated with multiple respective manufacturers may be applied in parallel.

The result parser 160 identifies a total number of unique device identifiers associated with the identified manufacturer. (Block 530). The example result parser of FIG. 1 identifies the total number of unique device identifiers associated with the identified manufacturer by performing a structured query language (SQL) count command on the accessed impression data. However, any other approach to identifying unique device identifiers may additionally or alternatively be used.

The example ratio processor 165 of FIG. 1 then identifies the de-duplication ratio using the manufacturer identity. (Block 540). In the illustrated example, the de-duplication ratio is identified by performing a lookup in the ratio database using the manufacturer identity. The example data table 200 of FIG. 2 represents de-duplication ratios stored in association with manufacturer identifiers. For example, if the manufacturer identity were determined to be “A,” the example ratio processor 165 would identify a de-duplication ratio of “0.95,” by selecting the de-duplication ratio from the example row 230 of FIG. 2.

The example ratio processor 165 of FIG. 1 applies the de-duplication ratio to the total number of unique device identifiers for the manufacturer to estimate the total number of unique devices associated with the manufacturer. (Block 550). To this end, the de-duplication ratio is multiplied by the total number of unique device identifiers associated with the manufacturer to estimate the total number of unique devices associated with the manufacturer.

The example ratio processor 165 determines whether any additional manufacturers are to be considered. (Block 560). If additional manufacturers of interest are identified in the impression data (Block 560 returns a result of YES), control returns to Block 520 where the next manufacturer is identified (or if the identity of the manufacturer is already known, control returns to Block 530 (i.e., Block 420 is skipped)). The example process of Block 520 (or Block 530) through Block 560 is repeated until estimation(s) of the total number of devices for all manufacturers of interest identified in the impression data are calculated. In some examples, the estimation(s) of the total number of devices are calculated only for certain manufacturers. For example, the estimate(s) may be prepared for the top ten manufacturers by number of unique devices, may be calculated for a pre-defined list of manufacturers, may be calculated for manufacturers having more than a threshold number of entries in the data set, etc.

If no additional manufacturers of interest exist (Block 560 returns a result of NO), the example ratio processor 165 determines whether any additional geographic regions of interest exist. In some examples, the example process of FIG. 5 is performed to generate a market share report that compares market shares across different geographic regions. For example, the market share report may identify market shares in Chicago, Ill., New York, N.Y.; and Los Angeles, Calif. If additional geographic regions of interest exist for inclusion on the market share report (Block 570 returns a result of YES), the process of Blocks 510 through 560 is repeated until market shares for each of the manufacturers of interest in each of the geographic regions of interest are calculated.

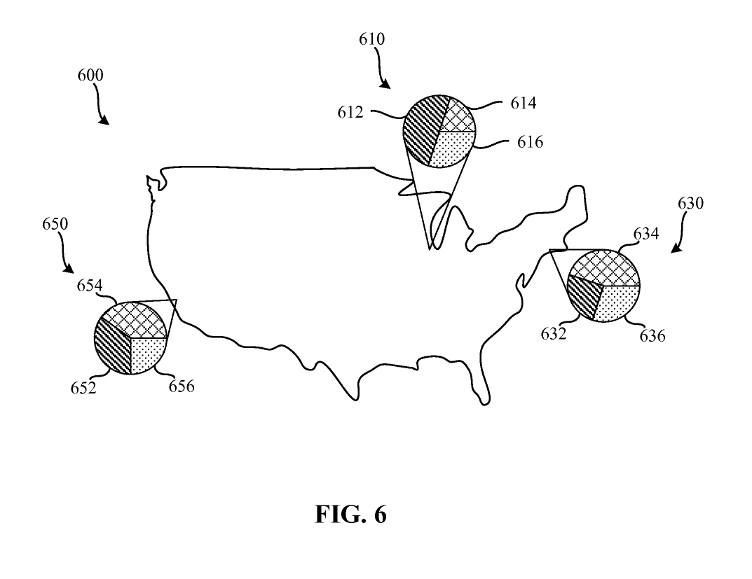

If no additional geographic regions of interest exist for inclusion on the market share report (Block 570 returns a result of NO), the example reporter 175 prepares a report depicting market share(s) of manufacturers for the geographic region(s) of interest (e.g., the geographic region(s) for which the impression data was queried). (Block 580). In the illustrated example, the total number(s) of devices for each of the manufacturer(s) of interest are used to calculate percentages representing the relative market share(s) of the manufacturer(s) of interest in the geographic region(s) of interest. While in examples disclosed herein multiple geographic regions are depicted by the example market share report (see FIG. 6), the market share report may be limited to a single geographic region. Once the example market share report is generated, the example process 500 of FIG. 5 terminates.

FIG. 6 is an example diagram of an example market share report 600 prepared by executing to the example operations represented by the flow diagram of FIG. 5. The example market share report identifies market share pie graphs 610, 630, 650, for three geographic regions (e.g., Chicago, Ill.; New York, N.Y.; and Los Angeles, Calif.). While in the illustrated example, three geographic regions are depicted, the example market share report generated by the example reporter 175 may identify any number of geographic regions. Moreover, while the geographic regions depicted in the example market share report 600 are cities, any other geographic region(s) (e.g., a county, a state, a postal code, a nation, a continent, etc.) may additionally or alternatively be used. Furthermore, while in the illustrated example, the market shares are shown using pie graphs, any other approach to displaying a market share may additionally or alternatively be used. For example, the market shares may be represented using bar graphs, data tables, etc.

Within the example market share report 600 of FIG. 6, a first market share graph 610 associated with a first geographic region (e.g., Chicago, Ill.) identifies that a first manufacturer has an estimated 50% market share 612, that a second manufacturer has an estimated 20% market share 614, and that a third manufacturer has an estimated 30% market share 616. A second market share graph 630 associated with a second geographic region (e.g., New York, N.Y.) identifies that the first manufacturer has an estimated 30% market share 632, that the second manufacturer has an estimated 45% market share 634, and that the third manufacturer has an estimated 25% market share 636. A third market share graph 650 associated with a third geographic region (e.g., Los Angeles, Calif.) identifies that the first manufacturer has an estimated 40% market share 552, that the second manufacturer has an estimated 35% market share 654, and that the third manufacturer has an estimated 25% market share 656.

FIG. 7 is a block diagram of an example hardware processor platform structured to execute the instructions of FIGS. 3, 4, and/or 5 to implement the example market share estimation server 105 of FIG. 1. The processor platform 700 can be, for example, a server, a personal computer, a mobile device (e.g., a cell phone, a smart phone, a tablet such as an iPad™), or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer.

The processor 712 of the illustrated example includes a local memory 713 (e.g., a cache), and executes instructions to implement the example result parser 160, the example ratio processor 165, and the example reporter 175. The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.). The example interface circuit 720 implements the example impression data accesser 150.

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives. The example mass storage 728 implements the example ratio database 170 and/or the example demographic database 171.

The coded instructions 732 of FIGS. 3, 4, and/or 5 may be stored in the mass storage device 728, in the volatile memory 714, in the non-volatile memory 716, and/or on a removable tangible computer readable storage medium such as a CD or DVD.

Methods, apparatus, and articles of manufacture have been disclosed herein to estimate mobile device market share. There are several technical advantages achieved by examples disclosed herein. For example, using a de-duplication approach disclosed herein to estimate market share based on advertisement impression data reduces the computation requirements (i.e., reduces the processor cycles needed) of preparing such a report when compared with existing methodologies. For example, when preparing a report using the de-duplication approach, multiplying a count of unique device identifiers by a de-duplication ratio is more computationally efficient than attempting to identify which unique identifiers are duplicative of each other (e.g., the unique identifiers actually identify a same device) because such identification might involve reviewing communications records of each device to identify which unique device identifiers it has used.

Furthermore, network bandwidth is conserved. For example, existing methodologies utilize interaction with telecommunications network providers to estimate a market share of different mobile device manufacturers. Such interaction might include, for example, querying a telecommunications network provider database. Generally, telecommunications network provider databases are difficult and/or time-consuming to query. Example approaches disclosed herein reduce the amount of queries to which telecommunications network provider databases must respond. As a result, example approaches disclosed herein reduce network traffic and the burden associated with responding to such network traffic on the telecommunications network provider.

In contrast to data from telecommunications network provider databases, advertisement impression data is readily available. Moreover, parsing impression data to filter the impression data to a particular manufacturer and/or applying a de-duplication ratio does not require as many computing resources (e.g., processor cycles, memory, bandwidth, etc.). As a result, reports of estimated mobile device market share can be prepared in a more timely and less computationally costly fashion.

Although certain example methods, apparatus, and articles of manufacture have been disclosed herein, the scope of coverage of this patent is not limited thereto. On the contrary, this patent covers all methods, apparatus, and articles of manufacture fairly falling within the scope of the claims of this patent.

What is claimed is:

1. A method to reduce a processing burden on a hardware processor estimating a number of actual mobile devices in a geographic region, the method comprising:
accessing, with the hardware processor, mobile device advertisement impression data from a first data structure, the mobile device advertisement impression data identifying manufacturers of corresponding mobile devices and respective device identifiers, at least two unique, non-identical, device identifiers of the advertisement impression data correspond to a same mobile device;
determining, with the hardware processor, a total number of unique device identifiers associated with a first manufacturer in the impression data;
accessing, with the hardware processor, a de-duplication ratio based on an identity of the first manufacturer, and
applying, with the hardware processor, the de-duplication ratio to the total number of unique device identifiers associated with the first manufacturer to estimate the number of actual mobile devices associated with the first manufacturer, the estimation performed without the hardware processor determining that the at least two unique device identifiers correspond to the same mobile device.

2. The method as disclosed in claim 1, wherein performing the estimation without the hardware processor determining that the at least two unique device identifiers correspond to the same mobile device avoids using processing cycles.

3. The method as disclosed in claim 1, wherein the mobile device impression data is first mobile device impression data associated with a first geographic region, and further including:
accessing, with the hardware processor, second mobile device advertisement impression data associated with a second geographic region;
identifying, with the hardware processor, a second total number of unique device identifiers associated with the first manufacturer from the second mobile device advertisement impression data; and
calculating the de-duplication ratio based on a known total of mobile devices associated with the first manufacturer divided by the second total number of unique device identifiers associated with first manufacturer from the second mobile device advertisement impression data.

4. The method as disclosed in claim 3, further including accessing the known total of mobile devices via mobile device sales information corresponding to the first manufacturer.

5. The method as disclosed in claim 3, wherein the second geographic region includes the first geographic region.

6. The method as disclosed in claim 3, wherein the second geographic region corresponds to a nation and the first geographic region corresponds to a location within the nation.

7. The method as disclosed in claim 6, wherein the first geographic region is a city within the nation.

8. The method as disclosed in claim 1, wherein accessing the mobile device advertisement impression data includes requesting the mobile device advertisement impression data from an advertisement exchange.

9. The method as disclosed in claim 1, wherein the total number of unique device identifiers is a first total number of unique device identifiers, the de-duplication ratio is a first de-duplication ratio, and further including:
identifying a second total number of unique device identifiers in the advertisement impression data which are associated with a second manufacturer;
accessing a second de-duplication ratio for the second manufacturer; and
applying the second de-duplication ratio to the second total number of unique device identifiers associated with the second manufacturer to calculate a number of actual mobile devices associated with the second manufacturer.

10. The method as disclosed in claim 9, further including preparing a report comparing the number of actual mobile devices for the first manufacturer to the number of actual mobile devices for the second manufacturer.

11. An apparatus to estimate a number of actual mobile devices, the apparatus comprising:
an impression data accesser to access mobile device advertisement impression data, the mobile device advertisement impression data identifying manufacturers of mobile devices and corresponding device identifiers;
a result parser to determine a total number of unique device identifiers associated with a first manufacturer in the advertisement impression data, at least two unique, non-identical, device identifiers of the advertisement impression data correspond to a same mobile device; and
a ratio processor to access a de-duplication ratio based on an identity of the first manufacturer, the ratio processor to apply the de-duplication ratio to the total number of unique device identifiers associated with the first manufacturer to estimate the number of actual mobile devices associated with the first manufacturer, the ratio processor to perform the estimation without determining that the at least two unique device identifiers correspond to the same mobile device, at least one of the impression data accesser, the result parser, or the ratio processor is implemented by hardware.

12. The apparatus as disclosed in claim 11, wherein:
the mobile device advertisement impression data is first mobile device advertisement impression data and is associated with a first geographic region;
the impression data accesser is to access second mobile device advertisement impression data associated with a second geographic region;
the result parser is to identify a second total number of unique device identifiers associated with the first manufacturer from the second mobile device advertisement impression data; and
the ratio processor is to calculate the de-duplication ratio based on a known total of mobile devices associated with the first manufacturer divided by the second total number of unique device identifiers associated with first manufacturer from the second mobile device advertisement impression data.

13. The apparatus as disclosed in claim 12, wherein the ratio processor is to access the known total of mobile devices via mobile device sales information corresponding to the manufacturer.

14. The apparatus as disclosed in claim 11, wherein the impression data accesser is to retrieve the advertisement impression data from an advertisement exchange.

15. The apparatus as disclosed in claim 11, wherein:
the total number of unique device identifiers is a first total number of unique device identifiers;
the de-duplication ratio is a first de-duplication ratio;
the result parser is to identify a second total number of unique device identifiers in the advertisement impression data which are associated with a second manufacturer, and
the ratio processor is to:
access a second de-duplication ratio for the second manufacturer; and
apply the second de-duplication ratio to the second total number of unique device identifiers associated with the second manufacturer to calculate a number of actual mobile devices associated with the second manufacturer.

16. The apparatus as disclosed in claim 15, further including a reporter to compare the number of actual mobile devices for the first manufacturer to the number of actual mobile devices for the second manufacturer.

17. A tangible machine-readable medium comprising instructions which, when executed, cause a server to at least:
access mobile device advertisement impression data, the mobile device advertisement impression data identifying manufacturers of corresponding mobile devices and respective device identifiers, at least two unique, non-identical, device identifiers of the advertisement impression data correspond to a same mobile device;
determine a total number of unique device identifiers associated with a first manufacturer in the impression data;
access a de-duplication ratio based on an identity of the first manufacturer; and
apply the de-duplication ratio to the total number of unique device identifiers associated with the first manufacturer to estimate the number of actual mobile devices associated with the first manufacturer, the estimation performed without determining that the at least two unique device identifiers correspond to the same mobile device.

18. The machine-readable medium as disclosed in claim 17, wherein the mobile device impression data is first mobile device advertisement impression data associated with a first geographic region, and the instructions, when executed, further cause the server to at least:
access second mobile device advertisement impression data associated with a second geographic region;
identify a second total number of unique device identifiers associated with the first manufacturer from the second mobile device advertisement impression data; and
calculate the de-duplication ratio based on a known total of mobile devices associated with the first manufacturer divided by the second total number of unique device identifiers associated with first manufacturer from the second mobile device advertisement impression data.

19. The machine-readable medium as disclosed in claim 18, wherein the instructions, when executed, cause the server to access the known total of mobile devices via mobile device sales information corresponding to the first manufacturer.

20. The machine-readable medium as disclosed in claim 18, wherein the second geographic region includes the first geographic region.

21. The machine-readable medium as disclosed in claim 18, wherein the second geographic region corresponds to a nation and the first geographic region corresponds to a location within the nation.

22. The machine-readable medium as disclosed in claim 21, wherein the first geographic region is a city within the nation.

23. The machine-readable medium as disclosed in claim 17, wherein the instructions, when executed, further cause the server to request the mobile device advertisement impression data from an advertisement exchange.

24. The machine-readable medium as disclosed in claim 17, wherein the total number of unique device identifiers is a first total number of unique device identifiers, the de-duplication ratio is a first de-duplication ratio, and the instructions, when executed, cause the server to at least:
identify a second total number of unique device identifiers in the advertisement impression data which are associated with a second manufacturer;
access a second de-duplication ratio for the second manufacturer; and
apply the second de-duplication ratio to the second total number of unique device identifiers associated with the second manufacturer to calculate a number of actual mobile devices associated with the second manufacturer.

25. The machine-readable medium as disclosed in claim 24, wherein the instructions, when executed, cause the server to prepare a report comparing the number of actual mobile devices for the first manufacturer to the number of actual mobile devices for the second manufacturer.
